(19) United States
(12) Patent Application Publication
(10) Pub. No.: US 2026/0154979 A1
(43) Pub. Date: Jun. 4, 2026

(54) TRAINING A NEURAL NETWORK TO SIMULTANEOUSLY ASCERTAIN SEMANTIC INFORMATON AND DEPTH INFORMATION

(71) Applicant: Robert Bosch GmbH, Stuttgart (DE)

(72) Inventors: Eashwara Sudharsan Erahan, Hildesheim (DE); Niklas Hahn, Hannover (DE); Oliver Lange, Hemmingen (DE); Tamas Kapelner, Hildesheim (DE)

(21) Appl. No.: 19/354,411

(22) Filed: Oct. 9, 2025

(30) Foreign Application Priority Data
Oct. 11, 2024 (DE) 10 2024 209 933.3

(51) Int. Cl. G06V 20/70; G06T 7/50; G06V 10/82

(52) U.S. Cl. CPC G06V 20/70; G06T 7/50; G06V 10/82

(57) ABSTRACT

A method for training an image processing neural network. The method includes: providing a set of training images; feeding each training image to a first trained neural network, which assigns semantic information to pixels, other image portions, and/or image features of an input image; feeding each training image to a second trained neural network, which assigns depth information to pixels, other image portions, and/or image features of an input image; fusing the semantic information and depth information to form a target map, which assigns semantic information to locations in three-dimensional space; processing, using the image processing neural network to be trained, each training image to form a map, which assigns semantic information to locations in three-dimensional space; checking, using a cost function, to what extent the map thus obtained is in line with the target map; optimizing parameters that characterize the behavior of the image processing neural network.

### FIELD

The present invention relates to image analysis, for example in the context of monitoring the environment of vehicles or robots.

### BACKGROUND INFORMATION

The at least partially automated guidance of vehicles and/or robots on company premises or even on public roads requires continuous monitoring of the environment of the vehicle or robot for other road users and for obstacles. A key source of information for environment monitoring is camera images, which are typically two-dimensional. However, it is important for the trajectory planning of the vehicle or robot to obtain a three-dimensional representation of the environment. At the same time, the representation must also contain semantic information so that, for example, objects of different types can be differentiated from one another.

Machine learning models that semantically segment an input image are already available. Machine learning models that add depth information to an input image are also available. When both semantic information and depth information are needed, the use of two machine learning models consumes a lot of memory and computing capacity. In this case, it is also not guaranteed that the semantic information and the depth information are completely in line with one another. Contradictions may occur at least locally.

### SUMMARY

The present invention provides a method for training an image processing neural network. This image processing neural network is designed to use a two-dimensional input image as the basis for ascertaining both semantic information and depth information for pixels, other image portions, and/or image features.

According to an example embodiment of the present invention, as part of this method, a set of training images is provided. These training images do not need to be labeled with target information, which the image processing network to be trained is ideally to ascertain from them. Instead, the training is self-supervised training, as shown below, in which the target information is ascertained from the training image itself in a different way.

For this purpose, each of the training images is fed to a first trained neural network, which assigns semantic information to pixels, other image portions, and/or image features of an input image. In particular, this is, for example, understood to mean that semantic information of any type is assigned to certain geometric shapes. For example, this geometric shape may be in the shape of a specific object and can assign a designation of this object, such as “car” or “truck,” to this shape. However, the geometric shape may, for example, also be a bounding box or another abstract shape that circumscribes the object.

Furthermore, each of the training images is also fed to a second trained neural network, which assigns depth information to pixels, other image portions, and/or image features of an input image. In this way, both semantic information and depth information are obtained.

This semantic information and the depth information are fused to form a target map, which assigns semantic information to locations in three-dimensional space. This target map is used as target information, which the image processing neural network to be trained is ideally to generate.

The image processing neural network to be trained now processes each training image to form a map, which assigns semantic information to locations in three-dimensional space. In this respect, this map can be understood as a point cloud or feature cloud, in which the points or features are annotated with semantic meanings.

A specified cost function is used to check to what extent the map thus obtained is in line with the target map. Parameters that characterize the behavior of the image processing neural network to be trained are optimized for the goal that the evaluation by the cost function is improved.

It has been found that, in this way, the first trained neural network and the second trained neural network as “co-teachers” impart to the neural network to be trained as “student” the particular portion of their knowledge needed to ascertain both semantic information and depth information for images from the domain or distribution of the training images. This domain or distribution may be significantly smaller in many applications than the domain or distribution of the training images on which the two “teachers” themselves were trained. In particular, as trained neural networks for the detection of semantic information or depth information, so-called foundation networks can, for example, be used, which have been trained on very large sets of training images from all possible applications and situations.

These foundation networks thus have knowledge that extends to a very wide range of input images. This extremely broad knowledge must be housed somewhere. Foundation networks therefore typically have very large architectures, which are characterized by correspondingly large numbers of parameters. In addition, the foundation networks for the detection of semantic information on the one hand and for the detection of depth information on the other hand have been independently trained on different sets of training images. In order to use both foundation networks, two correspondingly large sets of parameters must therefore be stored.

A specific application, on the other hand, such as the evaluation of traffic situations in the environment monitoring of vehicles or robots, involves only a much narrower class of input images. It is not important that the system installed in the vehicle or robot can also process images of classrooms, bathrooms, forest paths, or other locations where the vehicle or the robot will not be driving in the intended application. It is much more important that the system can operate with the limited resources available on board the vehicle or robot. Many applications have strict requirements in terms of installation space, heat dissipation, or energy consumption. The neural network used must therefore adapt to the available resources, and not vice versa.

If, according to the method of the present invention provided herein, two “teachers” together train a “student” on a specific domain or distribution of training images to detect both semantic information and depth information, the “student” can operate on a much smaller network architecture. For the processing of traffic situations, it no longer has to “drag along” the knowledge about bathrooms or classrooms, but this knowledge is only relevant to the extent that it can be used to learn basic skills that are also useful for the analysis of traffic situations.

At the same time, a common network that detects both semantic information and depth information can learn from the outset to produce consistent combinations of semantic information on the one hand and depth information on the other hand. For example, when detecting the semantic information that certain image portions belong to a vehicle, corresponding depth information must also be present at the corresponding location in the image. That is to say, the scene cannot be planar or flat there at the same time. If, on the other hand, initially, the first trained foundation network extracts semantic information and the second trained foundation network extracts depth information from the same input image, there may initially be at least local contradictions between the two items of information, which contradictions are to be resolved accordingly in a fusion.

It is thus possible in a particularly advantageous embodiment of the present invention to select an image processing neural network to be trained whose behavior is characterized by fewer parameters than the combination of the first and the second trained neural network. The image processing neural network can then be implemented even with limited hardware resources. For example, the number of parameters is a critical factor in how much internal memory a GPU or other hardware accelerator has to have in order to execute the network. The network must be able to operate with this internal memory since access to an external memory outside the GPU or hardware accelerator would be slower by orders of magnitude if it is even provided in the particular hardware architecture.

In a further, particularly advantageous embodiment of the present invention, a neural network to be trained is selected that comprises
a semantic branch for ascertaining semantic information,
a depth branch for ascertaining depth information, and
a preprocessing branch, which processes the input image to form an intermediate result that can be analyzed by both the semantic branch and the depth branch.

In this way, the required overall size of the network architecture can be reduced even further: What is required in terms of network to generate the intermediate result required by both the semantic branch and the depth branch only needs to be present once. Accordingly, the necessary training effort is also reduced. The preprocessing branch thus bundles basic skills needed for both detecting semantic information and detecting depth information. The preprocessing branch is thus somewhat analogous to school education, while the semantic branch and the depth branch are analogous to the subsequent vocational training or the subsequent studies.

In a further, particularly advantageous embodiment of the present invention, both the second trained neural network and the image processing neural network to be trained ascertain the depth information on a common normalized scale. In this way, for example, differences in transfer functions with which a three-dimensional scene from different cameras is converted into two-dimensional image information can, in particular, be compensated at least partially. For example, one camera may be a conventional camera, which preserves shapes as much as possible, while another camera is a fisheye camera, which captures a larger spatial area at the cost that the image contents are distorted. For example, the depth information may be rescaled to take only values between 0 and 1.

Furthermore, the common normalized scale may, in particular, be discretized into a plurality of bins, for example. In this case, the depth information can only take values from a discrete canon. In this way, the values in the target map, on the one hand, and the values supplied by the neural network to be trained, on the other hand, are better comparable with one another. For example, the depth information can only take values of full hundredths between 0 and 1 (i.e., 0.00, 0.01, 0.02, . . . , 1.00). The three-dimensional volume of the particular map can thus be considered to be divided into discrete slices, and semantic information is in each case written onto one or more of these discrete slices.

The assignment of depth information to bins does not need to be hard-coded in the form of thresholds. Instead, for example, the depth information can indicate a distribution function from which the association with a bin can be obtained. In this way, edge effects of the discretization can, in particular, be avoided.

In particular, the first trained neural network can, for example, be designed to ascertain masks and/or bounding boxes that correspond to object instances. In this way, contiguous units are created, which can be positioned as a whole in three-dimensional space, in particular with the help of the depth information supplied by the second trained neural network.

In particular, the first trained neural network can, for example, ascertain the position of pixels, other image portions, and/or image features with specific semantic meanings in a plane. The depth information supplied by the second trained neural network can then be used to shift these pixels, other image portions, or image features perpendicularly to the plane.

In a particularly advantageous embodiment of the present invention, for locations in three-dimensional space, the cost function compares items of semantic information that the target map, on the one hand, and the map ascertained by the image processing neural network to be trained, on the other hand, assign to these locations in each case. It is then possible, for example, to ascertain the extent to which the items of semantic information at the respective locations match on average. For example, it is also possible for comparison results for certain locations that are more important to the particular application to be weighted higher than comparison results for other, less important locations. For each object present in the scene, the score is based on whether the object was correctly detected and whether it was detected at the correct location.

Alternatively or in combination, the cost function can measure a similarity between the map ascertained by the image processing neural network to be trained, on the one hand, and the target map, on the other hand. This is a more summarizing measure and at the same time somewhat more resistant to a simple offset of the maps relative to each other.

In a further, particularly advantageous embodiment of the present invention, the fully trained image processing neural network is fed input images that were recorded by at least one Sensor. In this case, both semantic information and depth information can simultaneously be obtained for these input images. As explained above, in this case, the likelihood that these two items of information are consistent with each other is increased in comparison to a late fusion of semantic information and depth information that were obtained from separate neural networks.

In particular, the fully trained image processing neural network can, for example, be executed on a hardware platform whose resources are insufficient to operate the first trained neural network and the second trained neural network simultaneously. As explained above, as a result, the fully trained image processing neural network can, in particular, be executed, for example, in control units and similar devices of vehicles and/or robots, which have very limited hardware resources. In particular, the image processing neural network can, for example, be used to analyze images that were obtained when monitoring the environment of the vehicle or robot.

In particular, a control signal can, for example, be ascertained from the map supplied by the image processing neural network. This control signal can then be used to control a vehicle, a driver assistance system, a robot, a system for quality control, a system for monitoring areas, and/or a system for medical imaging. The improved training according to the proposed method also tends to improve the accuracy of the map supplied by the fully trained image processing neural network. This in turn increases the likelihood that the response of the controlled system to the control signal of the situation characterized by the input images, such as a traffic situation, is appropriate.

The method of the present invention may, in particular, be fully or partially computer-implemented. The present invention therefore also relates to a computer program with machine-readable instructions which, when executed on one or more computers and/or compute instances, cause the computer(s) and/or compute instance(s) to perform the method described. In this sense, control units for vehicles and embedded systems for technical devices that are likewise capable of executing machine-readable instructions are also to be regarded as computers. Compute instances may, for example, be virtual machines, containers, or serverless execution environments, which may, in particular, be provided in a cloud.

The present invention also relates to a machine-readable data carrier and/or to a download product with the computer program. A download product is a digital product that can be transmitted via a data network, i.e., can be downloaded by a user of the data network, and may, for example, be offered for sale in an online shop for immediate download.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of a method 100 for training an image processing neural network 1, according to an example embodiment of the present invention.

FIG. 2 shows an illustration of the self-supervised training of the image processing neural network 1 with two “teacher networks” 5 and 6, according to an example embodiment of the present invention.

### DETAILED DESCRIPTION OF EXAMPLE EMBODIMENTS

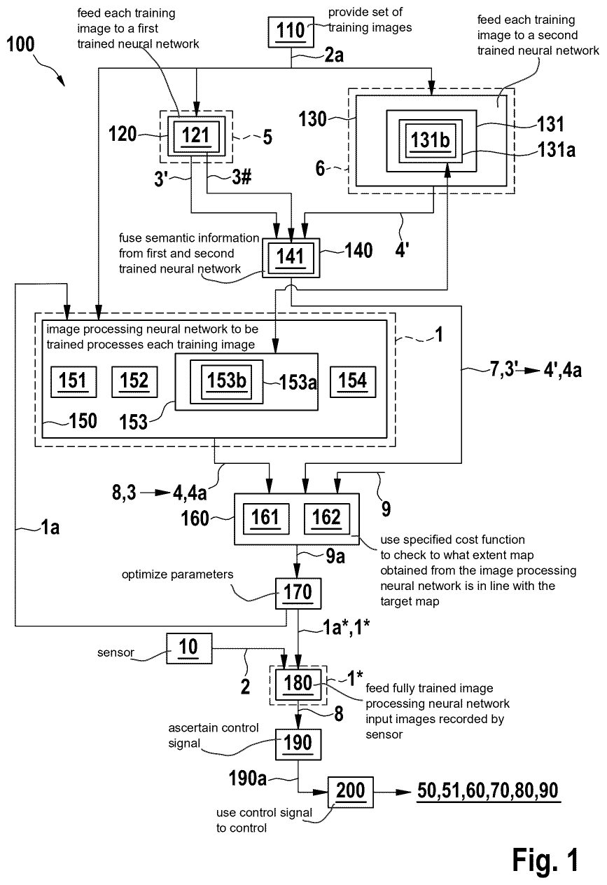

FIG. 1 is a schematic flowchart of an exemplary embodiment of the method 100 for training an image processing neural network 1. The image processing neural network 1 is designed to use a two-dimensional input image 2 as the basis for ascertaining both semantic information 3 and depth information 4 for pixels, other image portions, and/or image features.

In step 110, a set of training images 2a is provided. These training images 2a do not need to be annotated (labeled) with target outputs of the image processing neural network 1 or other previously known ground truth. Instead, the training of the image processing neural network 1 is self-supervised, as explained above.

In step 120, each training image 2a is fed to a first trained neural network 5. This first “teacher network” assigns semantic information 3′ to pixels, other image portions, and/or image features of an input image 2.

According to block 121, this first trained neural network 5 can, in particular, ascertain, for example, the position 3# of pixels, other image portions, and/or image features with specific semantic meanings in a plane.

In step 130, each training image 2a is fed to a second trained neural network 6. This second “teacher network” assigns depth information 4′ to pixels, other image portions, and/or image features of an input image 2.

According to block 131, the second trained neural network 6 can ascertain the depth information 4′ on a normalized scale. In particular, this normalized scale can, for example, be discretized according to block 131a into a plurality of bins. The assignment of the depth information 4′ to these bins can be “hard” via threshold values. However, the depth information 4′ can, for example, also indicate according to block 131b a distribution function from which the association with a bin can be obtained.

In step 140, the semantic information 3′ obtained from the first trained neural network 5 and the depth information 4′ obtained from the second trained neural network 6 are fused to form a target map 7, which assigns semantic information 3′ to locations 4a in three-dimensional space. In this respect, the depth information 4′ is encoded in the target map 7.

To the extent that, according to block 121, the position 3# of pixels, other image portions, and/or image features with specific semantic meanings in a plane has been ascertained, the depth information 4′ supplied by the second trained neural network 6 can be used according to block 141 to shift these pixels, other image portions, or image features perpendicularly to the plane.

In step 150, the image processing neural network 1 to be trained processes each training image 2a to form a map 8, which assigns semantic information 3 to locations 4a in three-dimensional space. In this respect, the depth information 4 supplied by the image processing neural network 1 to be trained is encoded in the map 8.

According to block 151, it is possible to select an image processing neural network 1 to be trained that comprises
a semantic branch 1c for ascertaining semantic information 3,
a depth branch 1d for ascertaining depth information 4, and
a preprocessing branch 1b, which processes the input image 2 to form an intermediate result 2# that can be analyzed by both the semantic branch and the depth branch.

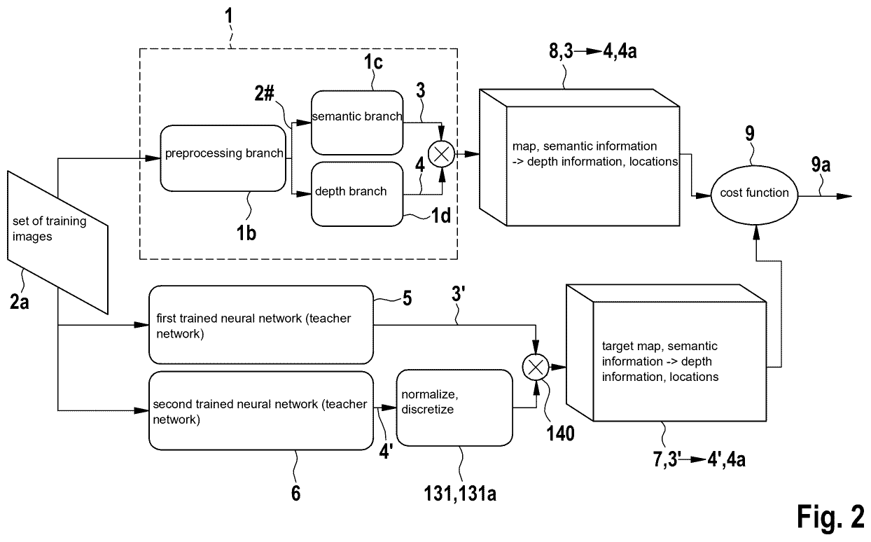

This architecture is explained in more detail in connection with FIG. 2.

According to block 152, it is possible to select an image processing neural network 1 to be trained whose behavior is characterized by fewer parameters 1a than the combination of the first trained neural network 5 and the second trained neural network 6.

According to block 153, the image processing neural network to be trained can ascertain the depth information 4 on the same normalized scale as the second trained neural network 6. In particular, this normalized scale can, for example, be discretized according to block 153a into a plurality of bins. The assignment of the depth information 4 to these bins can be “hard” via threshold values. However, the depth information 4 can, for example, also indicate according to block 153b a distribution function from which the association with a bin can be obtained.

According to block 154, the first trained neural network 5 can be designed to ascertain masks and/or bounding boxes that correspond to object instances.

In step 160, a specified cost function 9 is used to check to what extent the map 8 obtained from the neural network 1 to be trained is in line with the target map 7.

According to block 161, for example for locations in three-dimensional space, the cost function 9 can, in particular, compare
items of semantic information 3′, 3, which the target map 7 assigns to these locations in each case, with
items of semantic information, which the map 8 ascertained by the image processing neural network 1 to be trained assigns to these locations in each case.

Alternatively or in combination, the cost function 9 can measure according to block 162 a similarity between the map 8 ascertained by the image processing neural network 1 to be trained and the target map 7.

In step 170, parameters 1a that characterize the behavior of the image processing neural network 1 to be trained are optimized for the goal that the evaluation 9a by the cost function 9 is improved. The fully optimized state of the parameters 1a is denoted by reference sign 1a* and defines the fully trained state 1* of the image processing neural network 1.

In step 180, the fully trained image processing neural network 1* is fed input images 2 that were recorded by at least one sensor 10. This results in a map 8.

In step 190, a control signal 190a is ascertained from the map 8 supplied by the image processing neural network 1*.

In step 200, this control signal is used to control a vehicle 50, a driver assistance system 51, a robot 60, a system 70 for quality control, a system 80 for monitoring areas, and/or a system 90 for medical imaging.

FIG. 2 illustrates how the image processing neural network 1 can be trained in a self-supervised manner by means of a first trained “teacher network” 5, which supplies semantic information 3′, and by means of a second trained “teacher network” 6, which supplies depth information 4′. That is to say, the result 8 ascertained from a training image 2a by the image processing neural network 1 to be trained is evaluated based on a target result 7, which was ascertained from the training image 2a in a different way. It is thus not necessary for the training image 2a to be annotated (labeled) with a target result 7 or other ground truth.

In the example shown in FIG. 2, in the image processing neural network 1 to be trained, a preprocessing branch 1b first processes the training image 2a to form an intermediate result 2#. A semantic branch 1 c subsequently processes this intermediate result 2# to form semantic information 3. In parallel, a depth branch 1 d processes the intermediate result 2# to form depth information 4. The semantic information 3 and the depth information 4 are subsequently fused to form a map 8, which assigns semantic information 3 to locations 4a in three-dimensional space. In this respect, the depth information 4 is encoded in the map 8.

The processing of the intermediate result 2# to form semantic information 3 on the one hand and to form depth information 4 on the other hand, as indicated in FIG. 2, can be carried out simultaneously in different parts of the architecture of the image processing neural network 1 and on different resources of the hardware platform used. In this way, the map 8 as the final result is obtained as soon as possible. Alternatively, the semantic branch 1c and the depth branch 1d may also be executed sequentially on the same hardware. In particular, this may, for example, also be the same hardware that previously executed the preprocessing branch 1b. The image processing neural network 1 can thus be executed on a hardware platform that is only sufficient to execute one of the three network portions of preprocessing branch 1b, semantic branch 1c, and depth branch 1d at a time. This is in particular important when using the fully trained image processing neural network 1* in vehicles 50 or robots 60, where the available hardware resources are often severely limited.

The training image 2a is processed by the first trained “teacher network” 5 to form semantic information 3′and by the second trained “teacher network” 6 to form depth information 4′. According to blocks 131 and 131a of the method 100, the depth information 4′ is normalized to a uniform scale and discretized before being fused according to step 140 of the method 100 with semantic information 3′ to form a target map 7. In this respect, the target map 7 encodes the depth information 4′.

The cost function 9 evaluates to what extent the map 8 supplied by the image processing neural network 1 is in line with the target map 7. The score 9a obtained is used in step 170 of the method 100 as feedback for optimizing the parameters 1a of the image processing neural network 1.

1-16. (canceled)

17. A method for training an image processing neural network, which uses a two-dimensional input image as a basis for ascertaining both semantic information and depth information for: (i) pixels, and/or (ii) other image portions, and/or (iii) image features, the method for training the imaging processing network comprising the following steps:
providing a set of training images;
feeding each training image of the set of training images to a first trained neural network, which assigns semantic information to pixels and/or other image portions and/or image features of an input image;
feeding each training image of the set of training images to a second trained neural network, which assigns depth information to pixels and/or other image portions and/or image features, of an input image;
fusing the semantic information from the first trained neural network and depth information from the second trained neural network to form a target map, which assigns semantic information to locations in three-dimensional space;
processing, using the image processing neural network to be trained, each training image of the set of training images to form a map, which assigns semantic information to locations in three-dimensional space;
checking, using a specified cost function, to what extent the formed map is in line with the target map;
optimizing parameters that characterize a behavior of the image processing neural network to be trained, for a goal that an evaluation by the cost function is improved.

18. The method according to claim 17, wherein the image processing neural network to be trained includes:
a semantic branch configured to ascertain the semantic information,
a depth branch configured to ascertain depth information, and
a preprocessing branch, which processes an input image to form an intermediate result that can be analyzed by both the semantic branch and the depth branch.

19. The method according to claim 17, wherein the image processing neural network to be trained is an image processing neural network whose behavior is characterized by fewer parameters than a combination of the first trained neural network and the second trained neural network.

20. The method according to claim 17, wherein both the second trained neural network and the image processing neural network to be trained ascertain depth information on a common normalized scale.

21. The method according to claim 20, wherein the common normalized scale is discretized into a plurality of bins.

22. The method according to claim 21, wherein the depth information indicates a distribution function from which an association with a bin of the plurality of bins can be obtained.

23. The method according to claim 17, wherein the first trained neural network is configured to ascertain masks and/or bounding boxes that correspond to object instances.

24. The method according to claim 17, wherein:
the first trained neural network ascertains a position of pixels and/or other image portions and/or image features with specific semantic meanings in a plane, and
the depth information from the second trained neural network is used to shift the pixels and/or other image portions and/or image features, perpendicularly to the plane.

25. The method according to claim 17, wherein, for locations in three-dimensional space, the cost function compares items of semantic information that the target map, on the one hand, and the map formed by the image processing neural network to be trained, on the other hand, assign to each of the locations in the three-dimensional space.

26. The method according to claim 17, wherein the cost function measures a similarity between the map formed by the image processing neural network to be trained and the target map.

27. The method according to claim 17, wherein the trained image processing neural network is fed input images that were recorded by at least one sensor.

28. The method according to claim 27, wherein the trained image processing neural network is executed on a hardware platform whose resources are insufficient to operate the first trained neural network and the second trained neural network simultaneously.

29. The method according to one of claims 27, wherein:
a control signal is ascertained from the map supplied by the image processing neural network, and
the control signal is used to control a vehicle and/or a driver assistance system and/or a robot and/or a system for quality control and/or a system for monitoring areas and/or a system for medical imaging.

30. A non-transitory machine-readable data carrier on which is stored a computer program including machine-readable instructions for training an image processing neural network, which uses a two-dimensional input image as a basis for ascertaining both semantic information and depth information for: (i) pixels, and/or (ii) other image portions, and/or (iii) image features, the instructions, when executed on one or more computers and/or compute instances, causing the one or more computers and/or compute instances to perform the following steps comprising:
providing a set of training images;
feeding each training image of the set of training images to a first trained neural network, which assigns semantic information to pixels and/or other image portions and/or image features of an input image;
feeding each training image of the set of training images to a second trained neural network, which assigns depth information to pixels and/or other image portions and/or image features, of an input image;
fusing the semantic information from the first trained neural network and depth information from the second trained neural network to form a target map, which assigns semantic information to locations in three-dimensional space;
processing, using the image processing neural network to be trained, each training image of the set of training images to form a map, which assigns semantic information to locations in three-dimensional space;
checking, using a specified cost function, to what extent the formed map is in line with the target map;
optimizing parameters that characterize a behavior of the image processing neural network to be trained, for a goal that an evaluation by the cost function is improved.

31. One or more computers and/or compute instances with a non-transitory machine-readable data carrier on which is stored a computer program including machine-readable instructions for training an image processing neural network, which uses a two-dimensional input image as a basis for ascertaining both semantic information and depth information for: (i) pixels, and/or (ii) other image portions, and/or (iii) image features, the instructions, when executed on the one or more computers and/or compute instances, causing the one or more computers and/or compute instances to perform the following steps comprising:
providing a set of training images;
feeding each training image of the set of training images to a first trained neural network, which assigns semantic information to pixels and/or other image portions and/or image features of an input image;
feeding each training image of the set of training images to a second trained neural network, which assigns depth information to pixels and/or other image portions and/or image features, of an input image;
fusing the semantic information from the first trained neural network and depth information from the second trained neural network to form a target map, which assigns semantic information to locations in three-dimensional space;
processing, using the image processing neural network to be trained, each training image of the set of training images to form a map, which assigns semantic information to locations in three-dimensional space;
checking, using a specified cost function, to what extent the formed map is in line with the target map;
optimizing parameters that characterize a behavior of the image processing neural network to be trained, for a goal that an evaluation by the cost function is improved.
